(19) United States
(12) Patent Application Publication
(10) Pub. No.: US 2014/0205329 A1
(43) Pub. Date: Jul. 24, 2014

(54) IMAGE FORMING APPARATUS

(71) Applicant: CANON KABUSHIKI KAISHA, Tokyo (JP)

(72) Inventor: Koji Inoue, Tokyo (JP)

(73) Assignee: CANON KABUSHIKI KAISHA, Tokyo (JP)

(21) Appl. No.: 14/156,512

(22) Filed: Jan. 16, 2014

(30) Foreign Application Priority Data
Jan. 22, 2013 (JP) 2013-008983

(51) Int. Cl. G03G 15/16

(52) U.S. Cl. CPC G03G 15/2017
USPC 399/307

(57) ABSTRACT

A heating roller heats an inner surface of a toner integrating belt to heat a toner image carried on an intermediate transfer belt to a toner softening temperature or more to form a toner film. A cooler cools down the inner surface of the toner integrating belt to cool down the toner film under pressure.

### BACKGROUND OF THE INVENTION

1. Field of the Invention

The present invention relates to an image forming apparatus configured to transfer a toner image to a recording medium after forming the toner image into a toner film on an intermediate transfer body.

2. Description of the Related Art

A simultaneous transfer and fixing type image forming apparatus configured to transfer a toner image carried on an intermediate transfer body to a recording medium and to simultaneously fix the toner image to the recording medium as an image by overlapping and by heating and pressing them together is being put into practical use. However, because the simultaneous transfer and fixing type image forming apparatus has a possibility of causing unevenness of density on an image due to melt toner that flows into concavities of a surface of the recording medium, there is proposed a toner film transfer type image forming apparatus configured to form a toner film on an intermediate transfer body and to transfer the toner film to a recording medium.

Specifically, Japanese Patent Application Laid-open No. 2007-003689 discloses a method including processes of forming a toner film by heating and pressing a toner image carried on an intermediate transfer body, overlapping a recording medium with the toner film, and pressing them together to thermally adhere the toner film to the recording medium. Japanese Patent Application Laid-open No. 2006-195429 also discloses a method including processes of forming a toner film by heating and pressing a toner image carried on an intermediate transfer body, overlapping a recording medium with the toner film in which an adhesive layer has been formed by applying solvent, and pressing them together to physically adhere the toner film to the recording medium. Japanese Patent Application Laid-open No. 2005-266304 discloses a method including processes of forming a toner film by heating and pressing a toner image carried on an intermediate transfer body, by overlapping a recording medium with the toner film in which an adhesive layer has been formed by applying heat to a surface of the toner film, and pressing them together to thermally adhere the toner film to the recording medium.

The image forming apparatus described above heats the toner image to a temperature higher than a toner softening temperature in order to form the toner film by fusing toner particles carried on the intermediate transfer body. However, if the toner film on the intermediate transfer body is kept at the temperature higher than the toner softening temperature in a non-pressurized state, there is a case when a material of the toner film moves due to a surface tension and rises irregularly or the toner film is torn off and cracks. This phenomenon tends to be generated when the surface of the intermediate transfer body is coated with a thin toner film, and if it happens, it affects quality of an output image fixed on the recording medium.

### SUMMARY OF THE INVENTION

According to a first aspect of the present invention, an image forming apparatus includes an intermediate transfer body, a toner image forming portion configured to form a toner image corresponding to image data and to transfer the toner image to the intermediate transfer body, a pressing and heating portion configured to form a toner film by heating the toner image carried on the intermediate transfer body to a toner softening temperature or more in a pressurized condition, a pressing and cooling portion configured to cool down the toner film formed by the pressing and heating portion to a toner glass transition temperature or less in a pressurized condition, an adhesive layer forming portion configured to form an adhesive layer, adhering the toner film to a recording medium, on at least one of the toner film cooled down by the pressing and cooling portion and the recording medium, and a pressing portion configured to adhere the toner film to the recording medium by pressing the toner film, the adhesive layer and the recording medium in a body at a temperature of a toner glass transition temperature or less after forming the adhesive layer by the adhesive layer forming portion.

According to a second aspect of the present invention, an image forming apparatus includes an intermediate transfer belt, a toner image forming portion configured to form a toner image on the intermediate transfer belt, a toner film forming portion configured to form a nip portion with the intermediate transfer belt on a downstream of the toner image forming portion in a moving direction of the toner image and to form a toner film by heating the toner image at the nip portion, the toner film forming portion including a heating portion configured to heat the toner image and a cooling portion configured to cool down the toner film formed by the heating portion, and an adhesion portion configured to adhere the toner film with a recording medium.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of an image forming apparatus of a first embodiment.

FIG. 2 is a schematic diagram illustrating a sectional structure of an intermediate transfer belt.

FIG. 3 is a graph illustrating a cooling effect of a cooler.

FIG. 4 is a schematic diagram illustrating a configuration of an image forming apparatus of a second embodiment.

FIG. 5 is a schematic diagram illustrating a configuration of an image forming apparatus of a third embodiment.

FIG. 6 is a schematic diagram illustrating spaces between toner particles on the intermediate transfer belt.

FIG. 7 is a side view of the toner particle on the intermediate transfer belt.

FIG. 8 is a schematic diagram illustrating a toner extending on the intermediate transfer belt under a condition in which a contact angle is less than π/2.

FIG. 9 is a schematic diagram illustrating a toner extending on the intermediate transfer belt under a condition in which a contact angle is π/2 or more.

FIG. 10 is a graph illustrating a temperature distribution of a toner integrating unit.

FIG. 11A is a graph illustrating a relationship between a content and an elongation percentage of a thermoplastic elastomer of the toner.

FIG. 11B is another graph illustrating the relationship between the content and the elongation percentage of the thermoplastic elastomer of the toner.

FIG. 12A schematically illustrates a relationship between a content of the thermoplastic elastomer and an image defect.

FIG. 12B schematically illustrates a relationship between a content of the thermoplastic elastomer and an image defect.

FIG. 12C schematically illustrates another relationship between a content of the thermoplastic elastomer and an image defect.

FIG. 12D schematically illustrates a relationship between a content of the thermoplastic elastomer and an image defect.

### DESCRIPTION OF THE EMBODIMENTS

Embodiments of the present invention will be explained below in detail with reference to the drawings.

### First Embodiment

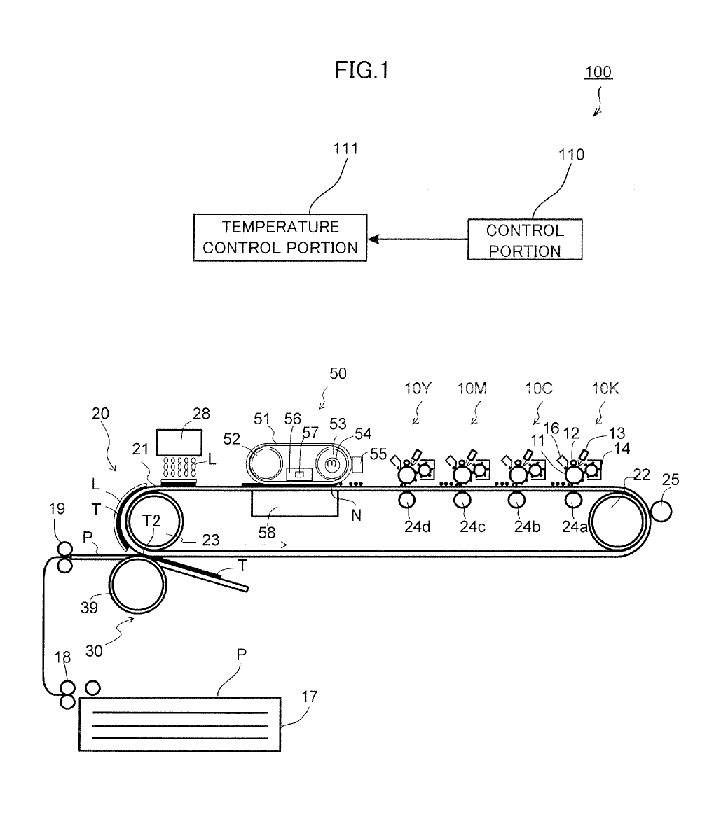

As shown in FIG. 1, an image forming apparatus of the embodiment includes an image forming portion 10K, i.e., one exemplary toner image forming portion, an intermediate transfer belt 21, i.e., one exemplary intermediate transfer body, and a toner integrating belt 51, i.e., one exemplary belt member. The image forming portion 10K is configured to form a toner image corresponding to image data and to transfer the toner image to the intermediate transfer belt 21. The toner integrating belt 51 is configured to form a toner image nip portion with the intermediate transfer belt 21.

The image forming apparatus also includes a heating roller 53, i.e., one exemplary pressing and heating portion, and a cooler 56, i.e., one exemplary pressing and cooling portion. The heating roller 53 is configured to heat the toner image carried on the intermediate transfer belt 21 to a toner softening temperature or more under pressure to form a toner film. The heating roller 53 heats the toner image while pressing an inner surface of the toner integrating belt 51.

The cooler 56 is configured to cool down the toner film formed by the heating roller 53 to a toner glass transition temperature or less by cooling, while pressing, the inner surface of the toner integrating belt 51.

The image forming apparatus further includes a liquid injection nozzle array 28, i.e., one exemplary adhesive layer forming portion, and a transfer and fixing roller 39, i.e., one exemplary pressing portion. The liquid injection nozzle array 28 is configured to apply an adhesive agent containing a water-soluble polymer and water to at least one of the toner film and the recording medium to form an adhesive layer that adheres the toner film with the recording medium. The water-soluble polymer of the adhesive agent contains a macromolecular monomer physically identical to the binder resin of the toner. The liquid injection nozzle array 28 applies the adhesive agent to an area corresponding to an outline of the toner film by operating in accordance to image data.

After forming the adhesive layer by the liquid injection nozzle array 28, the transfer and fixing roller 39 adheres the toner film to the recording medium by pressing the toner film, the adhesive agent, and the recording medium in a body at a temperature equal to or less than the glass transition temperature of the toner.

### (Image Forming Apparatus)

Specifically, FIG. 1 is a schematic diagram illustrating a configuration of the image forming apparatus 100 of the first embodiment. As shown in FIG. 1, the image forming apparatus 100 is a tandem intermediary transfer type full-color printer in which image forming portions 10Y, 10M, 10C and 10K of yellow, magenta, cyan, and black are arrayed along the intermediate transfer belt 21.

The image forming portion 10K is configured to form a black toner image and to transfer the toner image to the intermediate transfer belt 21. The image forming portion 10C is configured to form a cyan toner image and to transfer the toner image to the intermediate transfer belt 21. The image forming portions 10M and 10Y are configured to form magenta and yellow toner images and to transfer the toner images to the intermediate transfer belt 21, respectively.

The four color toner images transferred to and superimposed on the intermediate transfer belt 21 are conveyed to the toner integrating unit 50. The toner images are then processed as a toner film pasted on the intermediate transfer belt 21 by being cooled down after being heated and pressed. An adhesive agent is applied to the toner film on the intermediate transfer belt 21 with a liquid injection nozzle array (inkjet head) 28, and then the toner film is conveyed to a transfer and fixing nip portion T2. In the transfer and fixing nip portion T2, the toner film on the intermediate transfer belt 21 is laid on and pressed to a recording medium P taken out of a recording medium cassette 17 one by one and sent out by a registration roller 19. Thereby, an image is fixed on the recording medium P.

The transfer and fixing roller 39 is biased by a pressure spring not shown such that the roller 39 abuts on an outer peripheral surface of the intermediate transfer belt 21 supported by a secondary transfer inner roller 23 with a predetermined pressure to form the transfer and fixing nip portion T2. The transfer and fixing roller 39 rotates by being driven by the intermediate transfer belt 21.

A belt cleaning unit 25 is provided in contact with the intermediate transfer belt 21. The belt cleaning unit 25 is configured such that a nonwoven cleaning web comes into slidable contact with the surface of the intermediate transfer belt 21 to clean non-transferred toner and the adhesive agent remaining on the intermediate transfer belt 21.

### (Image Forming Portion)

The image forming portions 10Y, 10M, 10C and 10K are configured in the same manner except that the colors of the toners used in developing units 14 are different. Accordingly, only the image forming portion 10K will be described below and an overlapped explanation concerning the image forming portions 10Y, 10M and 10C will be omitted here.

The image forming portion 10K includes a charging roller 12, an exposure unit 13, the developing unit 14, a primary transfer roller 24a, and a drum cleaning unit 16 disposed around a photoconductive drum 11.

The photoconductive drum 11 is what a photoconductive thin film whose charge polarity is negative is formed around a peripheral surface of a base body made of aluminum and rotates at a processing speed of 100 mm/sec. The charging roller 12 is applied with vibration voltage in which AC voltage is superimposed on DC voltage and charges the peripheral surface of the photoconductive drum 11 with a homogeneous negative potential.

The exposure unit 13 is configured to form an electrostatic image of the image by scanning a laser beam binary-modulated corresponding to an image signal of a scan line on a peripheral surface of the photoconductive drum 11. The developing unit 14 is configured to develop the electrostatic image by using a two-component developer containing toner and carrier and to develop a toner image on the photoconductive drum 11.

The primary transfer roller 24a is applied with positive DC voltage and transfers the toner image on the photoconductive drum 11 to the intermediate transfer belt 21. The drum cleaning unit 16 is configured to recover the toner remained after the transfer operation by bringing a cleaning blade into slidable contact with the intermediate transfer belt 21.

### (Toner)

The developing unit 14 stores the two-component developer in which the toner of each color is mixed with the carrier. An average particle size of the toner is 7 μm. A maximum value of a toner loading amount of each color toner image is 8×10⁻3 [kg/m²]. The toner contains each color pigment and a binder resin that forms a particle. The binder resin is polyester based resin in the present embodiment. A toner softening temperature Tn is about 100° C. and a toner glass transition temperature Tg is about 70° C.

Any known polymer or resin for use as ordinary toner may be used for the binder resin of the toner. Specifically, the following polymers or resins can be used:

a homopolymer of styrene and its substitution product such as polystyrene, poly-p-chlorostyrene, and polyvinyl toluene;

a styrene-based copolymer such as a styrene-p-chlorostyrene copolymer, a styrene-vinyl toluene copolymer, a styrene-vinyl naphthalene copolymer, a styrene acrylic acid ester copolymer, a styrene methacrylic acid ester copolymer, a styrene-α-methyl methacrylate copolymer, a styrene-acrylonitrile copolymer, a styrene-vinylmethylether copolymer, a styrene-vinylethylether copolymer, a styrene-vinylmethyl ketone copolymer, and a styrene-acrylonitrile-indene copolymer; and

polyvinyl chloride, a phenol resin, a natural modified phenol resin, a natural modified maleic acid resin, an acrylic resin, a methacrylic resin, polyvinyl acetate, a silicon resin, polyurethane, a polyamide resin, a furan resin, an epoxy resin, a xylene resin, polyvinylbutyral, a terpene resin, a coumarone indene resin, a petroleum-based resin, and the like.

The glass transition temperature Tg can be determined from a measurement result of differential scanning calorimetry (DSC). The glass transition temperature is a physical property measured in accordance with JIS K7121 and means an intermediate point glass transition temperature described in the Standard. The softening temperature Tn can be measured by using a flow tester (CFT-500D: manufactured by Shimadzu Corporation). Specifically, the measurement is carried out by weighing 1.2 g of specimen to be measured and by using a die whose height is 1.0 mm and whose diameter is 1.0 mm under conditions of 4.0° C./min of rate of temperature rise, 300 seconds of preheating time, 5 kg of load, and 60 to 200° C. of temperature measuring range. A temperature at which a half of the specimen flows out of the die is defined to the softening temperature Tn. The glass transition temperature Tg is lower than the softening temperature Tn.

### (Intermediate Transfer Unit)

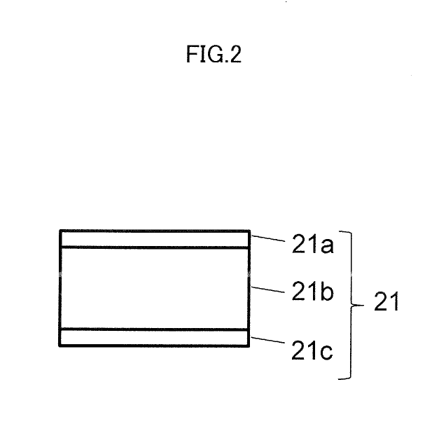

FIG. 2 is a section view schematically illustrating a configuration of the intermediate transfer belt. As shown in FIG. 1, an intermediate transfer unit 20 is constructed by stretching the intermediate transfer belt 21 around a drive roller 22, a secondary transfer inner roller 23, and primary transfer rollers 24a, 24b, 24c and 24d. The intermediate transfer belt 21 has a conveying width of 300 mm in a direction orthogonal to a toner image conveying direction.

As shown in FIG. 2, the intermediate transfer belt 21 is composed of a base layer 21a made of PI (polyimide) of 100 μm thick disposed on an inner side of the endless belt 21, an elastic layer 21b made of rubber of 300 uμm thick disposed on the base layer 21a, and a release layer 21c made of fluororesin of 30 μm thick coated as an outermost surface. The fluororesin may be exemplified by a PFA (a tetrafluoroethylene-perfluoro alkyl vinyl ether copolymer resin).

A predetermined tension is applied to the intermediate transfer belt 21 by the secondary transfer inner roller 23 spring-biased to an outside of the ringed belt 21, and the intermediate transfer belt 21 rotates in a direction of an arrow in FIG. 1 with a speed of 100 mm/sec. as a drive motor not shown rotationally drives the drive roller 22.

### (Toner Integrating Unit)

The toner integrating unit 50 is configured to apply heat and pressure to the toner image on the intermediate transfer belt 21 to melt the toner and to integrally form a thin film. The toner integrating belt 51 is in pressure-contact with an outer peripheral surface of the intermediate transfer belt 21 whose inner surface is supported by a pressure pad 58 and forms a toner film forming portion N. The toner integrating belt 51 includes a fluororesin such as a PFA (a tetrafluoroethylene-perfluoro alkyl vinyl ether copolymer resin) of 20 μm thick coated as a release layer on a Ni (nickel) base layer of 30 μm thick.

In the toner integrating unit 50, the toner integrating belt 51 is stretched between the tension roller 52 and the heating roller 53. A load of 400 N (40 kgf) is applied to the heating roller 53 by a pressure spring not shown to press the toner integrating belt 51 toward the pressure pad 58. A load of 100 N (10 kgf) is applied to the tension roller 52 by a pressure spring not shown to press the toner integrating belt 51 toward the pressure pad 58.

The heating roller 53 is rotationally driven by the drive motor not shown and is controlled such that the toner integrating belt 51 rotates with a same speed in the same direction with the intermediate transfer belt 21. However, it is also possible to arrange such that the toner integrating belt 51 is driven and rotated by the intermediate transfer belt 21. The application of the drive motor and the control of the toner integrating belt 51 by the drive motor may be applied also to the tension roller 52.

The heating roller 53 is provided with a halogen lamp 54 disposed within the heating roller 53 to heat the heating roller 53. The toner integrating belt 51 is heated by the heating roller 53. That is, the toner integrating unit 50 forms the film by heating and pressing the toner image on the intermediate transfer belt 21 by the toner integrating belt 51.

A temperature sensor 55 is disposed on an outer peripheral surface of the toner integrating belt 51 to detect temperature of the toner integrating belt 51. The temperature sensor 55 is a contact type thermistor. A temperature control portion 111 controls ON/OFF of power supplied to the halogen lamp 54 such that a surface temperature of the toner integrating belt 51 detected by the temperature sensor 55 is around 160° C. plus or minus 5° C.

### (Cooler)

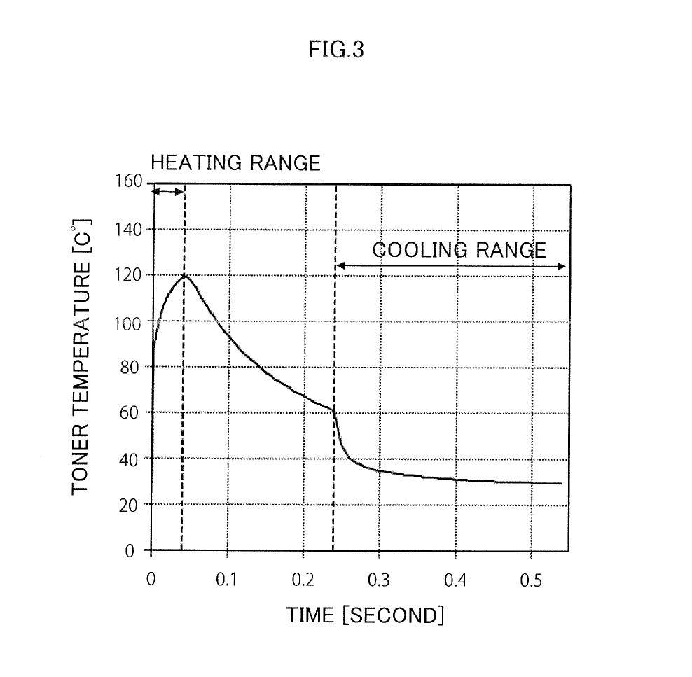

FIG. 3 is a graph illustrating a cooling effect of the cooler 56. As shown in FIG. 1, the cooler 56 is a water-cooling heat pump and cools the toner integrating belt 51 from inside thereof. A temperature sensor 57 detects a temperature of the inner surface of the toner integrating belt 51. The temperature sensor 57 is also a contact type thermistor. The temperature control portion 111 automatically adjusts an output of the cooler 56 such that the temperature of the inner surface of the toner integrating belt 51 detected by the temperature sensor 57 is kept at 30° C. plus or minus 2° C. A target temperature Tm of the temperature control of the cooler 56 is set such that it is equal to higher than atmospheric temperature and is equal to or less than the toner glass transition temperature Tg. The target temperature Tm is set at 30° C. here.

The toner image comes into contact with the toner integrating belt 51 heated by the heating roller 53 and melts by being heated up to the softening temperature Tn or more. The melted toner image is then cooled down to the glass transition temperature Tg or less and is formed into the toner film as the toner integrating belt 51 comes into contact with the cooler 56.

After that, the toner film T is separated from the toner integrating belt 51 at a position where the tension roller 52 separates from the intermediate transfer belt 21. Because a greater interfacial stress is generated on an interface between the toner integrating belt 51 and the toner film T more than that on an interface between the intermediate transfer belt 21 and the toner film T due to a curvature of the tension roller 52, the toner film T separates from the interface between the toner integrating belt 51 and the toner film T prior to the interface between the intermediate transfer belt 21 and the toner film T.

FIG. 3 shows a simulation result of thermal conductivity at the nip portion N where the toner integrating unit 50 is in contact with the intermediate transfer belt 21 carried out to find temperature of the toner image at each position on the intermediate transfer belt 21. A toner loading amount of the toner image was 8×10⁻³ [kg/m²]. As a result of the simulation of the thermal conductivity, it was confirmed that the toner image was heated up to about 120° C. in a heating range and was then cooled down to about 30° C. in a cooling range.

As shown in FIG. 1, a starting position of the heating range is a position where the toner image on the intermediate transfer belt 21 starts to come into contact with the toner integrating belt 51 in the first embodiment. An ending position of the heating range is a position where the toner integrating belt 51 starts to separate from the heating roller 53. A toner heating range is a range from the starting position to the ending position of the heating range, and its length is 4 mm. A distance from the ending position of the heating range to a head position of a cooling range in contact with the cooler 56 is 20 mm. A size of the cooling range in contact with the cooler 56 (nip width) is 30 mm in terms of the conveying direction of the intermediate transfer belt 21. A length in a conveying width direction of the cooling range orthogonal to the conveying direction is 300 mm which is substantially equal to the conveying width of the intermediate transfer belt 21. It is noted that the conditions of cooling down the toner image to the glass transition temperature Tg or less after heating up to the toner softening temperature Tn or more are not limited to the configurations and temperatures described with reference to FIGS. 1 and 3.

Thus, the toner integrating unit 50 composes the toner film forming portion that forms the nip portion N with the intermediate transfer belt 21 downstream the toner image forming portions 10Y through 10K in the toner image moving direction and that forms the toner film by heating the toner image at the nip portion N. Still further, the toner integrating unit 50 is configured such that the toner integrating belt 51 is endlessly wrapped between the heating roller (heating portion) 53 and the tension roller (rotary body) 52 and such that the inner peripheral surface of the belt 51 is cooled by the cooler 56 between the heating roller 53 and the tension roller 52. Therefore, the pressing and heating portion and the pressing and cooling portion can be constructed as an integral unit, and the formed toner film can be cooled down soon by the cooler 56. Still further, the toner integrating unit 50 extends between the heating roller 53 and the tension roller 52 and has the pressure pad (pressure member) 58 that presses the endless intermediate transfer belt 21 from an inner peripheral side thereof toward the toner integrating belt 51. Accordingly, it is possible to always apply a constant pressure to the toner image and the toner film, to adequately heat and cool the toner image and the toner film, and to prevent the melted toner from clumping together due to a surface tension.

### (Liquid Injecting Nozzle Array)

The liquid injection nozzle array 28 is constructed by diverting a so-called inkjet head having a printing range of a conveying width or more in which an image is formed for a use of spraying the adhesive agent to the toner film T on the intermediate transfer belt 21. The liquid injection nozzle array 28 is disposed in the direction of the conveying width of the intermediate transfer belt 21.

The control portion 110 sprays the adhesive agent homogeneously within a range limited to that of the toner film T by actuating the liquid injection nozzle array 28 within a sum total area of areas in which the respective color image data exist. The control portion 110 calculates a position and a passing timing of the toner film T conveyed while being pasted on the intermediate transfer belt 21 to apply the adhesive agent on the toner film T from each nozzle of the liquid injection nozzle array 28.

Because the adhesive agent is applied after integrating the toner image into the toner film T in the first embodiment, it is not necessary to worry about scattering the toner in applying the adhesive agent by the inkjet head or about causing disturbances in the toner image otherwise caused by fluidity of the adhesive agent.

### (Adhesive Agent)

The adhesive agent is preferable to be a liquid containing a water-soluble polymer and water. A component contained in water including the water-soluble polymer is desirable to be a hydrophilic material. Specific examples of the water-soluble polymer include polyvinyl alcohol, polystyrene acrylic acid, polyacrylic acid, polyglycerin, polyurethane, polyacrylamide, and others. Especially, polyurethane is preferable because it has a strong binding force when it is coagulated, water resistance, and high abrasion resistance.

A surfactant may be used as the water-soluble polymer component of the adhesive agent to disperse in water. Specific examples of the surfactant include an anionic surfactant such as fatty acid derivative sulfate ester, sulfonic acid type, and phosphate ester; a cationic surfactant such as quaternary ammonium salt, heterocyclic amine, and amine derivative; an amphoteric ion (nonionic) surfactant such as amino acid ester, amino acid, and sulfobetaine; a nonionic surfactant, polyoxyalkylene alkyl ether, polyoxyethylene alkylamine, and the like.

In the first embodiment, the adhesive agent was prepared by mixing and agitating polyurethane W-6010 (manufactured by Mitsui Chemicals, Inc.) by 15 wt. %, polyoxyethylene alkyl ether-based surfactant ID-206 (manufactured by NOF Corporation) by 1 wt. %, and water by 84 wt. %. Viscosity of the adhesive agent (at 25° C.) was 2.7 mPa·sec (corn and plate: φ60·1°). The viscosity of the adhesive agent was measured by using a RE80L viscometer (manufactured by Toki Sangyo) at 25° C.

It is necessary to suppress an amount of the adhesive agent to be supplied to a level not causing a curl in sheet if a main component of the adhesive agent is water. Specifically, a moisture amount to be applied is desirable to be 15 g/m² or less. Because an amount of the adhesive agent required in forming a urethane resin layer of 1 μm thick on an interface between the toner film T and the recording medium P by using a urethane resin solution of 15 wt. % is about 7 g/m² as the amount of moisture, no problem of curling occurs.

Because the toners are melted by heat, an adhesive force among the toners is fully assured. Meanwhile, in terms of adhesion between the toner film T and the recording medium P, it is possible to obtain enough fixing strength if the urethane resin layer of 1 μm thick exists as an adhesive layer on the interface between the toner film T and the recording medium P.

### (Transfer and Fixing Nip Portion)

As shown in FIG. 1, the toner film T on which the adhesive agent L has been applied on the intermediate transfer belt 21 is transferred and fixed simultaneously to the recording medium P fed to the transfer and fixing nip portion T2. Because the intermediate transfer belt 21 has an elastic layer, the intermediate transfer belt 21 can press the toner film T to corners of a surface of the recording medium P fed to the transfer and fixing nip portion T2 and to execute the simultaneous transferring and fixing process efficiently even to a rugged recording medium such as a plain sheet.

A contact angle of the adhesive agent L to the recording medium P is smaller than that to the surface of the intermediate transfer belt 21, so that an adhesive work between the adhesive agent L and the recording medium P is larger than that between the adhesive agent L and the intermediate transfer belt 21. Due to that, because the toner film T comes into contact with the recording medium P through the liquid layer of the adhesive agent L in the transfer and fixing nip portion T2, the toner film T is transferred to and fixed on the recording medium P when the recording medium P passes through the transfer and fixing nip portion T2. It is noted that an adhesive portion in which the toner film is adhered with the recording medium is formed by the transfer and fixing nip portion T2 and the liquid injection nozzle array 28 in the present embodiment.

### (Advantageous Effects of the First Embodiment)

The toner is melt by heat and is cooled and separated on the intermediate transfer belt 21, and the toner film T is pasted on the recording medium by the aqueous adhesive agent in the first embodiment. Because the cooler 56 is provided to quickly cool down the formed toner film T in the first embodiment, the melted toner clump together due to an effect of surface tension and the toner film is hardly damaged even if a toner loading amount is small. Still further, because the toner film T is adhered to the recording medium at the transfer and fixing nip portion T2 whose temperature is relatively low in the first embodiment, no power for heating is necessary. This configuration also requires no cooler otherwise provided downstream the transfer and fixing nip portion T2 to cool down the heated recording medium conveyed downstream.

Because the separation of the toner film T from the toner integrating belt 51 is carried out at the glass transition temperature Tg or less in the first embodiment, it is not necessary to worry about causing irregularities on a surface of the film by the toner film coagulated again after the separation. Accordingly, it is possible to form the toner film T having a smooth surface nature following a surface nature of the toner integrating belt 51. Because surface roughness of the toner film T affects adhesion with the recording medium, the smooth surface nature realizes high adhesion. While the surface roughness of the toner film T may cause entrapped liquid or unevenness of application in applying the adhesive agent on the surface of the film, the smooth surface nature makes it hard to cause such entrapped liquid or unevenness of application.

Because the adhesive agent mainly composed of water containing the water-soluble polymer is used in the first embodiment, no volatile organic compound (VOC) is generated from the recording medium while or after forming an image. Accordingly, this arrangement affects nothing in an environment in which the image forming apparatus is installed and requires no large-scale air-conditioning facility or air ventilation system. If a solvent adhesive agent is used in contrary, such an adhesive agent generates volatile organic compounds (VOC) when the solvent evaporates. Then, a large-scale apparatus for removing the volatile organic compound is required in order to deal with such gas. Still further, if an adhesive agent that swells or melts toner is used, a film condition is apt to be damaged by a surface tension of the melted toner as the adhesive agent acts on a whole film when a thickness of the toner film is thin. Due to that, gaps and unevenness are apt to be caused in an image that thinly coats a surface of the recording medium, thus dropping quality of an output image.

Because the first embodiment uses the adhesive agent that does not dissolve or swell the toner film T, it is possible to give the adhesiveness only to the surface of the toner film T in a wide temperature range without affecting the nature in a depth direction of the toner film T. Meanwhile, there is a problem that it is unpredictable how far an adhesive layer is formed in the depth direction in using the solvent adhesive agent.

Because the toner film T is adhered (pasted) to the recording medium by using the adhesive agent in the first embodiment, it is not necessary to heat the toner film. T again just prior to the transfer and fixing nip portion T2 like a case in which thermal adhesion is carried out. Then, it is not necessary to worry about causing cracks or undulations in the toner film T by heating the toner film T again. The first embodiment also makes it possible to assure required adhesive strength without damaging the toner film T even if a toner loading amount is small. The first embodiment requires no large-scale heating unit for quick heating. While absorptivity of light of halogen lamp differs depending on the colors of the toners, the first embodiment makes it possible not to worry about varying heating conditions of the toner film T by the colors.

### Second Embodiment

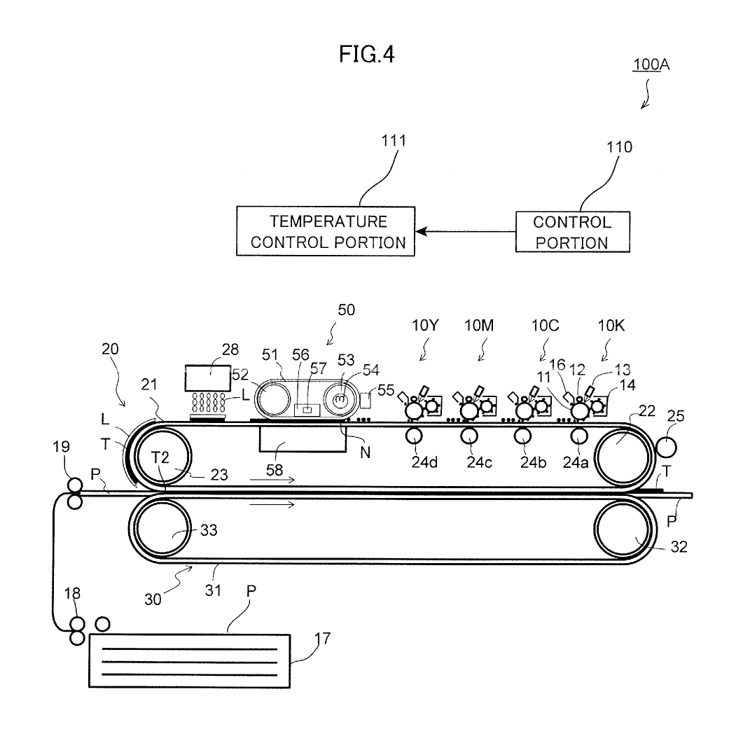

Next, an image forming apparatus of a second embodiment will be explained. FIG. 4 is a schematic diagram illustrating a configuration of the image forming apparatus of the second embodiment. While the image forming apparatus 100 configured to form the transfer and fixing nip portion T2 by using the transfer and fixing roller 39 has been explained in the first embodiment, a image forming apparatus 100A configured to form the transfer and fixing nip portion T2 by using a transfer and fixing belt 31 will be explained in the second embodiment. The parts of the second embodiment other than that are the same with those of the first embodiment, so that in FIG. 4, the same or corresponding components with those of the first embodiment will be denoted by the same reference numerals indicated in FIG. 1, and an overlapped explanation thereof will be omitted here.

As shown in FIG. 4, the second embodiment adopts a transfer and fixing unit 30 on the pressurizing side of the transfer and fixing nip portion T2. The transfer and fixing unit 30 includes the transfer and fixing belt 31, and transfer and fixing belt tension rollers 32 and 33 as rotary shafts. The transfer and fixing belt 31 is stretched around the transfer and fixing belt tension rollers 32 and 33 spaced apart in parallel and is rotationally driven by the intermediate transfer belt 21. The transfer and fixing belt tension rollers 32 and 33 are pressed respectively toward the drive roller 22 and the secondary transfer inner roller 23 with a predetermined pressurizing force by a bias portion such as a pressure spring not shown.

The above configuration also brings about the same effects with those of the first embodiment, and the shape of the pressure member is not limited to that of the first embodiment as long as the transferring and fixing nip portion is formed.

### Third Embodiment

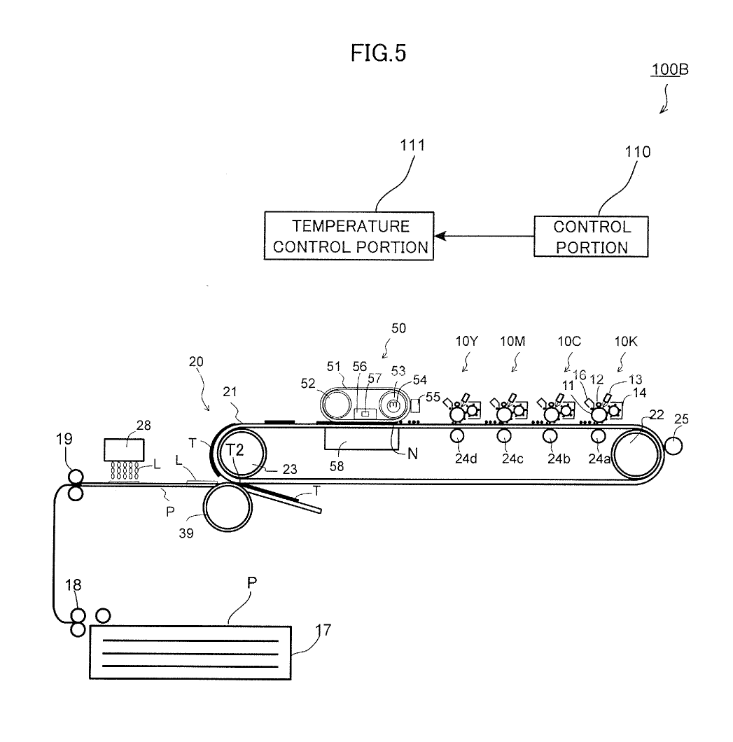

FIG. 5 is a schematic diagram illustrating a configuration of an image forming apparatus of a third embodiment. The adhesive agent has been applied to the toner film T by disposing the liquid injection nozzle array 28 so as to face the intermediate transfer belt 21 in the first embodiment. Meanwhile, an image forming apparatus 100B of the third embodiment applies the adhesive agent to the recording medium by disposing the liquid injection nozzle array 28 at a recording medium feeding portion that feeds the recording medium to the transfer and fixing nip portion T2. The parts of the third embodiment other than that are the same with those of the first embodiment, so that in FIG. 5, the same or corresponding components with those of the first embodiment will be denoted by the same reference numerals indicated in FIG. 1, and an overlapped explanation thereof will be omitted here.

As shown in FIG. 5, the transfer and fixing roller 39 which is one exemplary pressing portion adheres the toner film to the recording medium by integrally pressing the recording medium on which an adhesive layer that adheres the toner film has been formed beforehand and the toner film which has been cooled by the cooler 56 at the toner glass transition temperature or less.

The liquid injection nozzle array 28 is disposed at a position where the liquid injection nozzle array 28 can apply the adhesive agent on the recording medium P before the toner film T is transferred to the recording medium P. That is, the present embodiment is configured such that the liquid injection nozzle array 28 is disposed upstream in a conveying direction of the recording medium P more than the transfer and fixing nip portion T2 on a recording medium P conveying path so that the liquid injection nozzle array 28 can apply the adhesive agent to the recording medium before the recording medium reaches to the transfer and fixing nip portion T2. The control portion 110 calculates a position where the recording medium P comes into pressure contact with the toner film T on a basis of image data and causes the liquid injection nozzle array 28 to discharge the adhesive agent L at a timing when the recording medium P comes to be conveyed to the application position. After that, the recording medium P comes into pressure contact with the toner film T through the adhesive agent L at the transfer and fixing nip portion T2, and the toner film T is pasted on the recording medium P. As described in the second embodiment, the pressure member in the pressure side mechanism shown in FIG. 5 is not limited to the roller member and a belt member may be also used as long as the transfer and fixing nip portion T2 is formed.

### <Control of Toner Loading Amount>

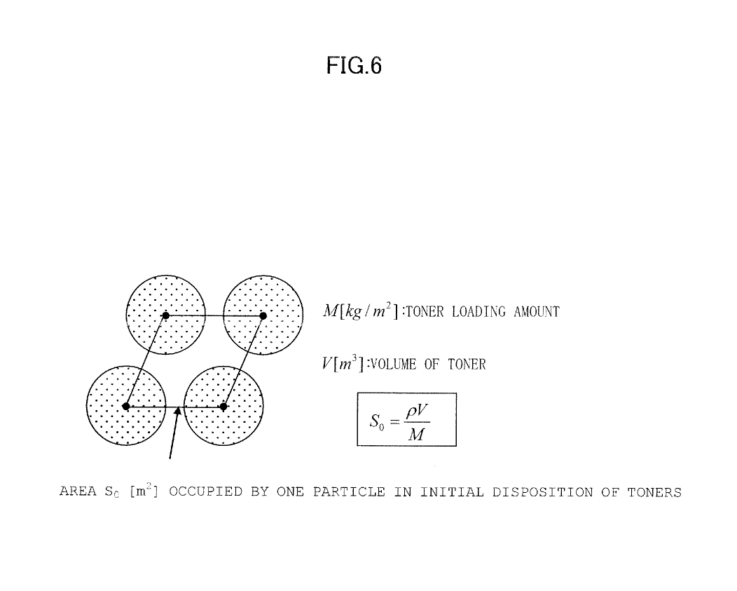

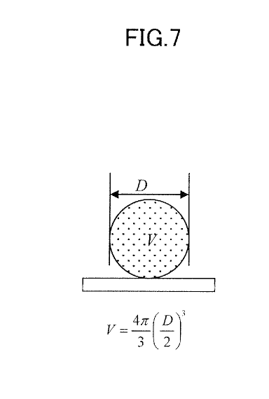

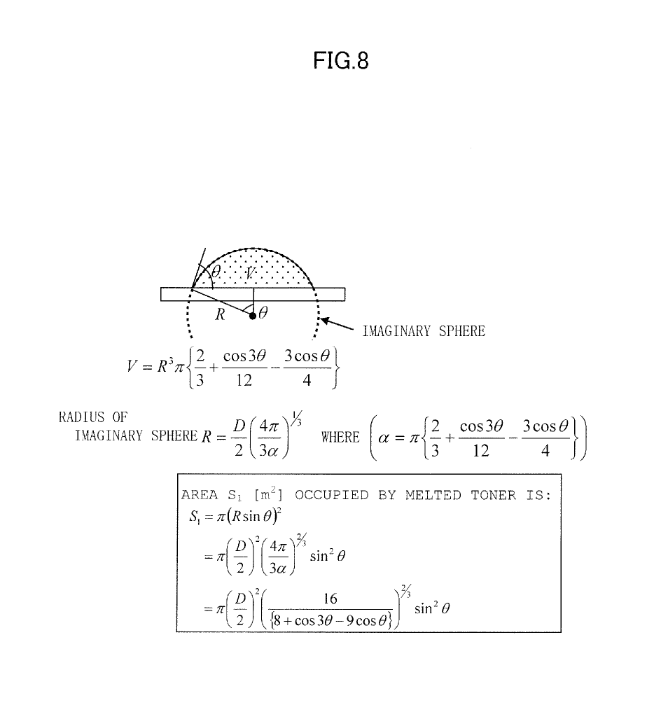

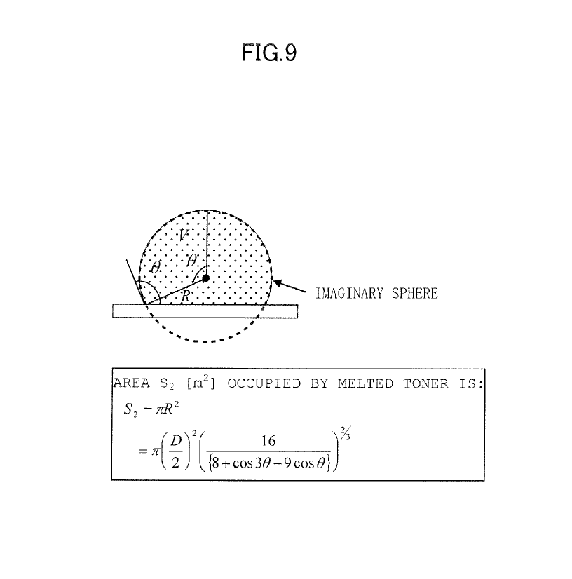

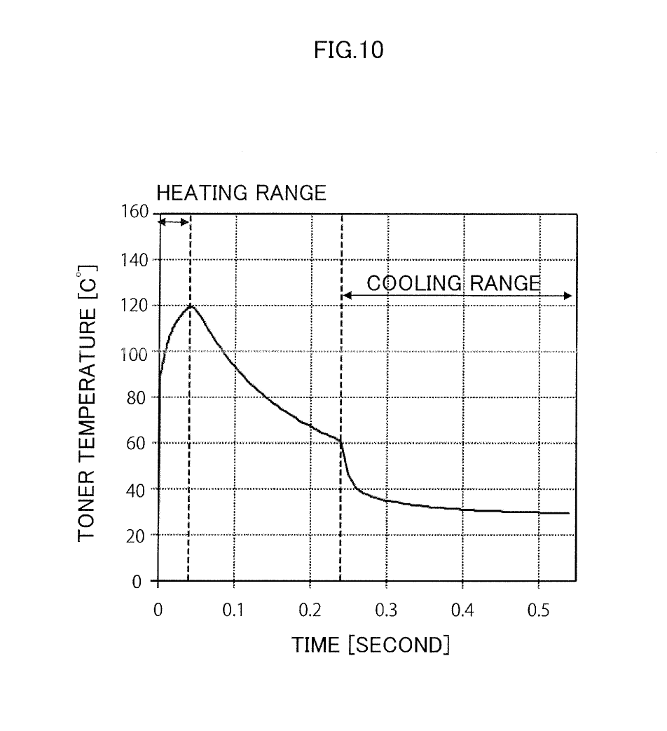

Next, controls of the toner loading amount of the image forming apparatuses 100, 100A and 100B of the first through third embodiments described above will be explained by exemplifying the image forming apparatus 100 of the first embodiment. FIG. 6 is a schematic diagram illustrating spaces between toner particles on the intermediate transfer belt, FIG. 7 is a side view of the toner particle on the intermediate transfer belt, FIG. 8 is a schematic diagram illustrating a toner extending on the intermediate transfer belt under a condition in which a contact angle is less than π/2, FIG. 9 is a schematic diagram illustrating a toner extending on the intermediate transfer belt under a condition in which a contact angle is π/2 or more, and FIG. 10 is a graph illustrating a temperature distribution of the toner integrating unit.

An image on a surface of a recording medium coated by the toner film without any gap will be referred to as a ‘solid image’ here for convenience. The solid image is formed by fixing the toner in a state of a film having no gap between the melted toner particles on the recording medium. In order to obtain predetermined reflection density with less toner loading amount in each color image, it is preferable to form the solid image to make the base of the recording medium invisible at least at a maximum value of grayscale (255/255 for example).

If the toner loading amount is fully large, spaces between the toner particles are filled by the toner, so that it is possible to realize the gapless toner film just by heating without pressure because the melted toners cohere with each other. However, lately, a cut of an amount of toner to be used has become an important issue in a background of resource saving caused by the environmental problem, and it is demanded to realize the equal reflection density with less toner loading amount. However, if the toner loading amount is reduced, a gap emerges between melted toners, a recording medium is exposed, and the reflection density of a fixed image drops just by heating the toner.

Accordingly, if the grayscale maximum value is tried to be realized with less toner loading amount in the image forming apparatus 100, it is necessary to fill up the gaps between the melted toner particles by spreading an area of the melted toners by heating the toners by the heating roller 53 in the pressurized condition.

Here, an area coating the recording medium by the squashed toners increases by increasing the pressure applied by the heating roller 53. However, a limit of visual recognition of human is about 20 μm, and if size of squashed one toner particle is larger than 20 μm, a particle feeling becomes worse and visible image quality drops in a halftone region of an output image. It is because the reflection density of the image is brought about by the squashed one toner particle and the recording medium between the toner particles in the low-density halftone region of the output image. Accordingly, it is preferable to set a maximum value of the toner loading amount of a toner image formed in the image forming portion 10K between a lower limit value by which a diameter of the squashed toner particle reaches 20 μm and an upper limit value by which melted toners coat the intermediate transfer belt without gap even if no pressure is applied.

Gaps are generated between toner particles as shown in FIG. 6 in a case where toner particles are adhered on the intermediate transfer belt 21 in a condition of relatively less toner loading amount of one layer or less. An average area S₀ [m²] occupied by one toner particle can be expressed by the following equation, where the toner loading amount is denoted as M [kg/m²], an average volume of one toner particle is V [m³], and true density of the toner is ρ [kg/m³]:

$${S}_{0} = \frac{ρ V}{M} \qquad Eq . 1$$

It is necessary to spread the toner particle on the intermediate transfer body to an area exceeding the area S₀ described above in order to form the solid image. Then, an area of the toner spread on the intermediate transfer belt only by heat will be explained first.

Assume here that a non-melted toner particle exists on the intermediate transfer belt 21 as shown in FIG. 7 and then the toner particle melts by heat and its coating area expands as shown in FIG. 8. A volume V [m³] of the non-melted toner can be expressed by the following equation, where an average particle size of the toner is D [μm]:

$$V = \frac{4 π}{3} {( \frac{D}{2} )}^{3} \qquad Eq . 2$$

As shown in FIG. 8, the melted toner particle comes into contact with the intermediate transfer belt 21 with a contact angle θ and is formed into a cap-like shape such that it corresponds to a part of a sphere, i.e., an imaginary sphere. A volume V [m³] of the melted toner can be expressed by the following equation, where a radius of the imaginary sphere is R [m]:

$$V = {R}^{3} π ( \frac{2}{3} + \frac{cos 3 θ}{12} - \frac{3 cos θ}{4} ) \qquad Eq . 3$$

Because Equation 2 is equivalent to Equation 3, the radius R [m] of the imaginary sphere can be expressed by the following equation:

$$R = \frac{D}{2} {( \frac{4 π}{3 α} )}^{1 / 3} \\ ( α = π ( \frac{2}{3} + \frac{cos 3 θ}{12} - \frac{3 cos θ}{4} ) ) \qquad Eq . 4$$

That is, in a case where the contact angle is 0<θ≦π/2 (a so-called permeation wetting state) as shown in FIG. 8, an area S₁ [m²] of the melted toner particle coating on the intermediate transfer belt 21 can be expressed by the following equation:

$$\begin{matrix}{S}_{1} = {π ( R sin θ )}^{2} \\ = {π ( \frac{D}{2} )}^{2} {( \frac{16}{8 + cos 3 θ - 9 cos θ} )}^{2 / 3} {sin}^{2} θ\end{matrix} \qquad Eq . 5$$

Meanwhile, if temperature of the melted toner is low or wettability between the intermediate transfer belt 21 and the melted toner is bad, the contact angle θ exceeds π/2 (a so-called adhesion wetting state) as shown in FIG. 9. In this case, an area S₂ [m²] of the melted toner particle coating on the intermediate transfer belt 21 is smaller than that of the case shown in FIG. 8. The area S₂ [m²] of a circle of radius R formed by the melted toner particle that spreads on the intermediate transfer belt 21 can be expressed by the following equation:

$$\begin{matrix}{S}_{2} = π {R}^{2} \\ = {π ( \frac{D}{2} )}^{2} {( \frac{16}{8 + cos 3 θ - 9 cos θ} )}^{2 / 3}\end{matrix} \qquad Eq . 6$$

It results in from the relationship described above that the toner particles do not cohere with each other and are not formed into a film if the area S₁ or S₂ [m²] of the melted toner particle projected on the intermediate transfer belt 21 is smaller than the average area S₀ occupied by one toner particle in the initial disposition of the toner particles.

Therefore, in the case where the contact angle is 0<θ≦π/2, the toner particles are not formed into a film only by heat and need to be pressed under condition of the following equation:

$$M < \frac{2 ρ D}{3 {sin}^{2} θ} {( \frac{8 + cos 3 θ - 9 cos θ}{16} )}^{2 / 3} \qquad Eq . 7$$

In a case where the contact angle is π/2<θ, the toner particles are not also formed into a film only by heat and need to be pressed under condition of the following equation:

$$M < \frac{2 ρ D}{3} {( \frac{8 + cos 3 θ - 9 cos θ}{16} )}^{2 / 3} \qquad Eq . 8$$

Apart of an image whose grayscale is lower than the solid image is put into an isolated state in which gaps exist between the toner particles even in forming a toner image in a range of Equation 7 or 8, and the isolated toner must be spread at least more than the average area S₀ in order to form the solid image.

However, it is not preferable that a dot diameter of the isolated toner exceeds 20 μm or more, i.e., the limit of visual recognition, when the toner loading amount is less than a certain amount. An area occupied by the isolated toner by being pressed and deformed must be at least the average area S₀ [m²] or more in order to fill up the gaps between the toner particles. Therefore, in order to keep a diameter Dd [μm] of one dot of the isolated toner particle to be 20 μm or less, it is necessary to set the toner loading amount M [kg/m²] within a range specified by the following equation:

$${D}_{d} [ m ] ( = 2 \sqrt{{S}_{d} / π} ) \\ \frac{ρ V}{{10}^{- 10} π} < M \qquad Eq . 9$$

In order to confirm the relationship between the toner loading amount M [kg/m²] and the formation of the toner film, an experiment was carried out under condition of D=7 μm, ρ=1.2×10³ kg/m³, and θ=88°. As a result, gaps were left among toner particles when M=3×10⁻³ [kg/m²] and the toner particles were formed into a film when M=4×10⁻³ [kg/m²].

When Equation 7 was used because the contact angle is 0<θ≦π/2, a lowest toner loading amount by which the toner particles are formed into a film was M=3.4×10⁻³ [kg/m²], which coincides with the estimation. A least toner loading amount M by which a granular feeling is inconspicuous in a fixed image surface is M=4.3×10⁻³ [kg/m²] or more.

The toner by which the toner image is formed on the intermediate transfer belt 21 as shown in FIG. 1 is D=7 μm, ρ=1.2×10³ kg/m³, and M=3×10⁻³ [kg/m²], and the contact angle with the intermediate transfer belt 21 after heating is θ=88°.

The toner particles (toner image) are not formed into a film only by heating under this condition as described above, and it is necessary to press the toner particles to form them into a film. That is, in order to form the toner image formed on the intermediate transfer belt 21 into a film, the toner image is heated and pressed by the toner integrating unit 50.

Then, temperature of the toner at each position on the intermediate transfer belt 21 was found by carrying out a simulation on heat conduction under the condition in which the toner loading amount is M=3×10⁻³ [kg/m²]. Although the toner loading amount was different from that of the simulation of heat conduction shown in FIG. 3, a substantially same result was obtained in terms of the temperature of the toner.

As shown in FIG. 10, the toner was heated up to about 120° C. in the heating region and then cooled down to about 30° C. in the cooling region in the nip portion formed by the toner integrating unit 50 and the intermediate transfer belt 21.

It is noted that the invention is not limited to the combination of the temperatures shown in FIG. 10 because a surface temperature of the toner integrating belt 51 just needs to be the toner softening temperature Tn or more and a temperature of the cooler 56 just needs to be set at the toner glass transition temperature Tg or less.

Thus, the image forming portion of the image forming apparatus 100, 100A or 100B controls the toner loading amount such that the following Equation 10 is fulfilled when the contact angle is 0<θ≦π/2 and such that the following Equation 11 is fulfilled when the contact angle is π≦θ>π/2, where D [μm] denotes the average particle size of the toner, ρ [kg/m³] denotes the true density of the toner particle, θ [rad] denotes the toner contact angle on the intermediate transfer body at the fusion point of the toner, and M [kg/m²] denotes the maximum value of the toner loading amount:

$$\begin{matrix}\frac{ρ V}{{10}^{- 10} π} < M < \frac{2 ρ D}{3 {sin}^{2} θ} {( \frac{8 + cos 3 θ - 9 cos θ}{16} )}^{2 / 3} & Eq . 10 \\ \frac{ρ V}{{10}^{- 10} π} < M < \frac{2 ρ D}{3} {( \frac{8 + cos 3 θ - 9 cos θ}{16} )}^{2 / 3} & Eq . 11\end{matrix}$$

Accordingly, it is possible to assure the required reflection density of each color image with less toner loading amount without deteriorating the granular feeling of a low density halftone image.

### (Toner)

The toner used in the image forming apparatuses 100, 100A and 100B of the first through third embodiments described above will be explained by exemplifying the image forming apparatus 100 of the first embodiment. As shown in FIG. 1, the image forming portion 10K forms a toner image by using the toner containing a thermoplastic elastomer and the binder resin at least in a partial solid-soluble condition. The thermoplastic elastomer is contained in the toner particle with a rate of 20% or more and 100% or less to the binder resin. A rate of sum total of a rugged area of a surface of a recording medium in a projected area to the projected area in a normal direction of the surface of the recording medium will be referred to as a rate of rugged area. At this time, an area elongation percentage of the toner film at the temperature of the toner film in the transfer and fixing nip portion T2 is greater than the rate of rugged area. Due to that, the toner film follows throughout the ruggedness without breaking.

### (Rate of Rugged Area of Recording Medium)

It is possible to obtain a favorable image if a recording medium has a highly smooth surface like a glossy sheet and a coated sheet because a toner film T is transferred and fixed as a film. However, if a recording medium whose superficial ruggedness is large such as an uncoated sheet, a rough sheet and a recycled sheet, a defective image tends to be generated because the toner film cannot follow the ruggedness and may cause cracks, even if the elastic layer of the intermediate transfer belt 21 can follow. If the toner film cannot follow the superficial ruggedness of the recording medium, an enough adhesive force cannot be obtained between the recording medium and the toner film and a part of the toner film may rise up because the toner film cannot fully come into contact with concave portions of the recording medium. The toner film breaks at the part corresponding to the concave portion on the surface of the recording medium, thus dropping an image quality.

Accordingly, in order to follow the superficial ruggedness of the recording medium and to keep the adhesion without breaking the toner film, the toner film is required to have an area elongation percentage corresponding to or greater than a rate of (sum total of rugged area contained in unit area)/(unit area) of the recording medium. In a case when the toner film is transferred and fixed to the recording medium after cooling down to the glass transition temperature Tg or less in particular, it is necessary to use a toner film whose elongation percentage is large under the glass transition temperature Tg because it is unable to expect that the toner film would be softened and follow the rugged surface by heat.

The rate of the rugged area can be calculated by SX-Viewer which is analysis software dedicated for Micromap manufactured by Ryoka Systems Inc. from surface shape data measured by Micromap. When the rate of the rugged area of a recording medium (Model No. CS814) having a relatively smooth surface and that of a recording medium (Model No. Fox River Bond) having a relatively large rugged surface were measured, the rate of the rugged area of the former recording medium was 1.07 and that of the latter recording medium was 1.59. Rates of the rugged area of commercially available recording mediums are around 1.05 to 1.6 in general.

### (Content of Thermoplastic Elastomer)

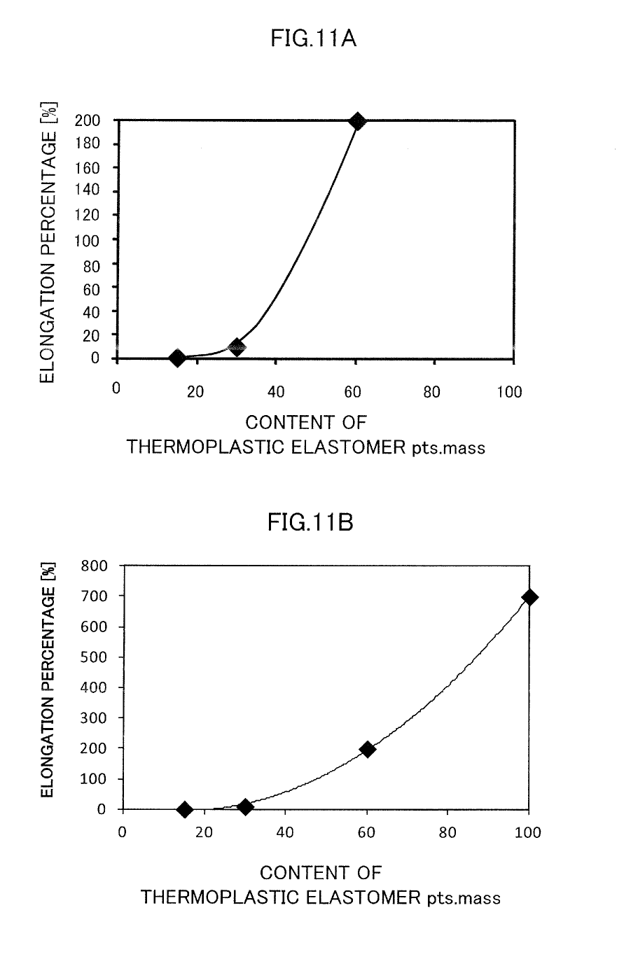

FIGS. 11A and 11B are graphs illustrating relationships between contents of the thermoplastic elastomer and elongation percentages of the toner. It was experimentally confirmed that it is possible to give high elongation percentage to a toner film when the toner containing the binder resin and the thermoplastic elastomer. The elongation percentage of the toner was measured by a tensile test. The toner was molded into a shape of a plate by hot pressing to prepare a test piece of 20 mm×2 mm×0.8 mm. One end of the test piece was fixed to a base, another end was fixed to a tensile unit movable in a certain axial direction, and the test piece was pulled with a speed of 50 mm/sec. at 25° C. The test piece breaks down when it is pulled by a certain pulling distance. What the pulling distance by which the test piece breaks down is converted to a rate to a length of the test piece before pulling the piece is defined as a toner elongation percentage. The toner elongation percentage is an elongation percentage in a uniaxial direction.

As shown in FIGS. 11A and 11B, the more the content of the thermoplastic elastomer, the higher the toner elongation percentage is. The binder resin and the thermoplastic elastomer are also preferable to be solid-soluble (compatible) with each other in order to give a high toner elongation percentage to the toner film, and the toner elongation percentage drops if the binder resin and the thermoplastic elastomer are not compatible. If the content of the thermoplastic elastomer increases to 20 pts·mass or more with respect to the binder resin in the case where the binder resin is solid-soluble with the thermoplastic elastomer, elongation characteristic of the toner starts to be expressed and the elongation percentage rises sharply. It was confirmed that the toner elongation percentage rises up to 200% when the content of the thermoplastic elastomer is 60 pts·mass. The toner elongation percentage of 200% satisfies a required condition as an elongation percentage of the recording medium whose rate of rugged area is 1.05 to 1.6. Considering a disturbance applied to a fixed image and an error of the rate of rugged area, at least 80% or more of the toner elongation percentage is enough. That is, the content of the thermoplastic elastomer is preferable to be 20 pts·mass or more and less than 100 pts·mass, or is more preferable to be 30 pts·mass or more and 60 pts·mass or less with respect to 100 pts·mass of the binder resin.

Because the toner containing the thermoplastic elastomer and the binder resin is used in the embodiments described above, the elongation percentage of the formed toner film remarkably increases as compared to toner containing no thermoplastic elastomer. Therefore, even if the rate of rugged area of a recording medium is large, it is possible to keep the toner film and to transfer and fix the toner film to the recording medium without breaking the toner film. That is, the use of the toner having the large toner elongation percentage enables the toner film to follow the superficial ruggedness of the recording medium without causing cracks. While any toner may be used in the present invention, the toner is preferable to have a toner elongation percentage greater than the rate of rugged area of the recording medium P from an aspect of assuring image quality of an output image.

### (Types of Binder Resin)

It is possible to use any known polymer or resin normally used as toner for the binder resin. Specifically, the following polymers or resins can be used:

a homopolymer of styrene and its substitution product such as polystyrene, poly-p-chlorostyrene, and polyvinyl toluene;

a styrene-based copolymer such as a styrene-p-chlorostyrene copolymer, a styrene-vinyl toluene copolymer, a styrene-vinyl naphthalene copolymer, a styrene acrylic acid ester copolymer, a styrene methacrylic acid ester copolymer, a styrene-α-methyl methacrylate copolymer, a styrene-acrylonitrile copolymer, a styrene-vinylmethylether copolymer, a styrene-vinylethylether copolymer, a styrene-vinylmethyl ketone copolymer, and a styrene-acrylonitrile-indene copolymer; and

polyvinyl chloride, a phenol resin, a natural modified phenol resin, a natural modified maleic acid resin, an acrylic resin, a methacrylic resin, polyvinyl acetate, a silicon resin, a polyester resin, polyurethane, a polyamide resin, a furan resin, an epoxy resin, a xylene resin, polyvinylbutyral, a terpene resin, a coumarone indene resin, a petroleum-based resin, and the like. Among them, a favorable result could be obtained by the polyester resin which excels in strength, even though its molecular weight is low, and in compatibility with the thermoplastic elastomer.

### (Acid Value of Binder Resin)

The binder resin is preferable to contain an ionizable group such as a carboxylic acid group, a sulfonic acid group, and an amino group within its resin skeleton, and is more preferable to contain a carboxylic acid group. An acid value of the binder resin is preferable to be 3 to 35 mg KOH/g, and is more preferable to be 8 to 25 mg KOH/g. The acid value is a number of mgs of potassium hydroxide required to neutralize free fatty acid, resin acid and others contained within a specimen of 1 g. A measurement was carried out in accordance to JIS-K0070. When the acid value of the binder resin exceeds 35 mg KOH/g, charge-up tends to be remarkable in a low humidity environment. Meanwhile, if the acid value of the binder resin is less than 3 mg KOH/g, electrification characteristic drops, so that it is improper to use for the toner.

### (Glass Transition Temperature of Binder Resin)

It is possible to determine the compatibility of the binder resin and the thermoplastic elastomer from a result of measurement of the toner glass transition temperature Tg carried out by means of a DSC (differential scanning calorimeter). It is because the glass transition temperature Tg of the binder resin does not change and the glass transition temperatures Tg of the binder resin and of the thermoplastic elastomer are independently detected when they are not compatible. The glass transition temperature (Tg) is a physical property measured in accordance to JIS-K7121 and means an intermediate point glass transition temperature described in the Standard.

It is preferable to increase the glass transition temperature Tg of the toner used in the present embodiment to be 60° C. or more than the normal toner in order to make the binder resin compatible with the thermoplastic elastomer. Because the glass transition temperature Tg of the thermoplastic elastomer is lower than a room temperature, the glass transition temperature Tg of the binder resin drops by making them compatible with each other. Therefore, if the glass transition temperature Tg of the binder resin is less than 60° C., the toner tends to agglomerate in a storage condition, i.e., a so-called blocking phenomenon tends to occur.

### (Softening Temperature of Binder Resin)

A softening temperature (TM) of the binder resin is preferable to be 70° C. or more and 110° C. or less, is more preferable to be 80° C. or more and 110° C. or less, and is most preferable to be 80° C. or more and 100° C. or less.

If the softening temperature Tm of the binder resin is less than 70° C., offset resistance is weak and high offset resistance cannot be expected even if the toner contains a release agent. Still further, if a temperature in fixing the toner is high, a toner melt component permeates remarkably into tissues of the recording medium, and surface smoothness of an output image is liable to be damaged. Meanwhile, if the softening temperature (Tm) of the binder resin is higher than 110° C., fixability of the image drops.

The softening temperature (Tm) of the binder resin can be measured by using a flow tester (CFT-500D: manufactured by Shimadzu Corporation). Specifically, the measurement was carried out by weighing 1.2 g of specimen to be measured and by using a die whose height is 1.0 mm and whose diameter is 1.0 mm under conditions of 4.0° C./min of rate of temperature rise, 300 seconds of preheating time, 5 kg of load, and 60 to 200° C. of temperature measuring range. A temperature at which a half of the specimen flows out of the die is defined to the softening temperature.

### (Type of Thermoplastic Elastomer)

The thermoplastic elastomer of the present embodiment is not specifically limited and a known thermoplastic elastomer may be used. The thermoplastic elastomer refers to a resin having fluidity when it is heated, having rubber-like resilience in a normal temperature, and having 100% or more of elongation percentage in a room temperature.

While thermoplastic elastomers such as a styrene-based thermoplastic elastomer, an olefin-based thermoplastic elastomer, a vinyl chloride-based thermoplastic elastomer, a polybutadiene-based thermoplastic elastomer, and an urethane-based thermoplastic elastomer can be used as the thermoplastic elastomer of the present embodiment, it is preferable to use the urethane thermoplastic-based elastomer in particular when an adhesive agent containing the urethane-based water-soluble polymer is used. It has been confirmed by experiments that the urethane-based thermoplastic elastomer increases an affinity with the adhesive agent, that the toner film is strongly adhered to the recording medium, and that the toner film is hardly damaged even if the toner film is bent repeatedly. Exemplary urethane-based thermoplastic elastomers include ester-type urethane-based thermoplastic elastomer, ether-type urethane-based thermoplastic elastomer, and the like.

The ester-type urethane-based thermoplastic elastomer has a structure expressed by the following general formula (2):

(—O—R′—OCO—NH—R—NHCO—)n (2)

R′: polyester

Specifically, the ester-type urethane-based thermoplastic elastomer can be exemplified by what is produced by a polyaddition reaction of polyester, obtained by polycondensation of polybasic coarboxylic acid such as adipic acid and terephthalic acid and polybasic alcohol, with diisocyanate.

The ether-type urethane-based thermoplastic elastomer has a structure expressed by the following general formula (3):

(—O—R′—OCO—NH—R—NHCO—)n (3)

R′: polyether

Specifically, the ether-type urethane-based thermoplastic elastomer can be exemplified by what is produced by causing difunctional polyether such as polyoxypropylene glycol (PPG) and polyoxytetramethylene glycol (PTMG) to react with diisocyanate.

If a polyester resin is used for the binder resin for example, it is preferable to select an ester type urethane thermoplastic elastomer for the thermoplastic elastomer from the aspect of the compatibility with the polyester resin. A combination of the binder resin with the thermoplastic elastomer may be selected appropriately by considering the compatibility of the binder resin with the thermoplastic elastomer as described above.

### (Softening Temperature of Thermoplastic Elastomer)

The softening temperature of the thermoplastic elastomer is preferable to be lower than the softening temperature of the binder resin in the present invention. If the softening temperature of the thermoplastic elastomer is higher than that of the binder resin, only the binder resin within the toner melts first in the fixing process and bending resistance of the fixed item tends to drop. That is, the softening temperature of the thermoplastic elastomer is more preferable to be 60° C. or more and to be the softening temperature or less of the binder resin. If the softening temperature of the thermoplastic elastomer is less than 60° C., the blocking resistance tends to drop.

### (Melting Point of Thermoplastic Elastomer)

A melting point of the thermoplastic elastomer is preferable to be 40° C. or more and 120° C. or less and is more preferable to be 50° C. or more and 100° C. or less in the present invention. If the melting point of the thermoplastic elastomer is less than 40° C., the blocking easily occurs depending on an environment in which the toner is stored. Meanwhile, if the melting point of the thermoplastic elastomer exceeds 120° C., the low temperature fixability tends to drop.

While the elongation percentage of the thermoplastic elastomer is 100% or more, it is more preferable to be 300% or more in the present invention. Still further, a weight-average molecular weight of the thermoplastic elastomer is preferable to be 50,000 or more. If the weight-average molecular weight is smaller than 50,000, performance of giving flexibility to the fixed item drops and bending resistance of an output image tends to drop.

### (Toner Coloring Material and Release Member)

The toner contains a coloring material as necessary. The coloring material may be a known organic pigment, oil dye, carbon black, magnetic powder, or the like. These coloring materials may be used solely or in mixture, or in a state of solid solution. The coloring material contained in the toner is selected from aspects of hue angle, chromaticness, brightness, light resistance, OHP transparency, and dispersibility to the toner. Contents of the coloring materials of cyan, magenta, yellow, and black is preferable to be 1 pts·mass or more and less than 20 pts·mass with respect to 100 pts·mass in total of the binder resin and the thermoplastic elastomer. If the content is less than 1 pts·mass, coloring may be insufficient. If the content exceeds 20 pts·mass, the coloring material not included in the toner particle tends to increase.

The cyan coloring material may be exemplified by a copper phthalocyanine compound and its derivative, an anthraquinone compound, a basic dye lake compound, and others. The magenta coloring material may be exemplified by a condensed azo compound, a diketopyrrolopyrrole compound, an anthraquinone compound, a quinacridone compound, a basic dye lake compound, a naphthol compound, a benzimidazolone compound, a thioindigo compound, a perylene compound, and others. The yellow coloring material may be exemplified by compounds and others typified by a condensed azo compound, an isoindolinone compound, an anthraquinone compound, an azo-metal complex, a methine compound, an arylamide compound, and others. The black coloring material may be exemplified by carbon black, magnetic powder, or what is toned to black by using the yellow, magenta, and cyan coloring materials.

### (Toner Release Agent)

The toner contains a release agent as necessary. The exemplary release agents include low molecular weight polyolefins such as polyethylene; silicons having a melting point (softening point) by heating; fatty acid amides such as oleic amide, erucic acid amide, ricinoleic acid amide, and stearic acid amide. The exemplary release agents also include ester waxes such as stearyl stearate; botanical wax such as carnauba wax, rice wax, candelilla wax, Japan tallow, and jojoba oil; and animal waxes such as bees wax. The exemplary release agents also include mineral and oil waxes such as montan wax, ozocerite, ceresin, paraffin wax, microcrystalline wax, Fischer-Tropsch wax, and ester wax; and their modifications.

The release agent is preferable to have the melting point which is 150.0° C. or less, is more preferable to have the melting point which is 40.0° C. or more and 130.0° C. or less, and is most preferable to have the melting point which is 40.0° C. or more and 110.0° C. or less. Preferably, the release agent is used to be 10 pts·mass or more and 20 pts·mass or less with respect to 100 pts·mass in total of the binder resin and the thermoplastic elastomer.

### (Toner Manufacturing Method)

The toner can be manufactured by using known manufacturing methods such as, specifically, a kneading and grinding method, a dissolution suspension method, a suspension polymerization method, and the emulsion aggregation method. However, the emulsion aggregation method was used in the present embodiment from a reason that this method permits to easily control the compatibility of the binder resin and the thermoplastic elastomer.

### (Comparison Test)

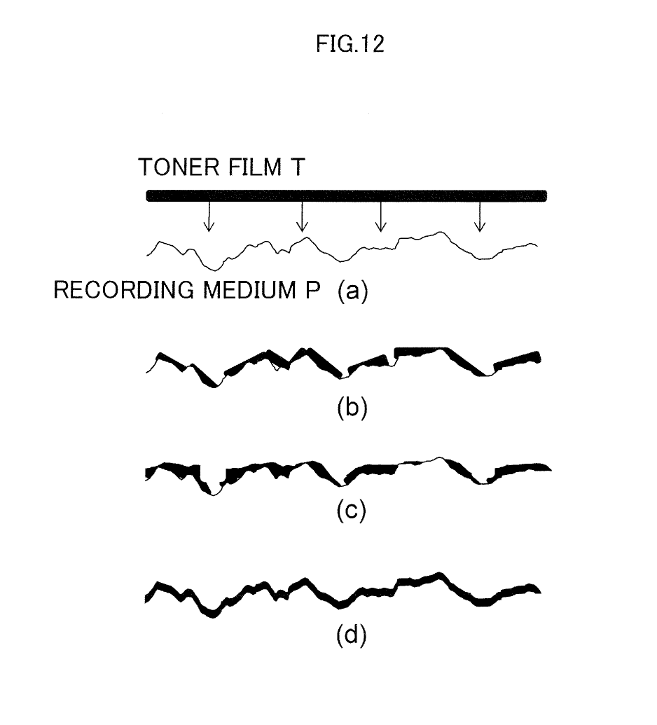

FIGS. 12A through 12D schematically illustrate a relationship between a content of the thermoplastic elastomer and an image defect. Three types of toners were manufactured by the emulsion aggregation method by differentiating the contents of the thermoplastic elastomer and images were formed on a recording medium P whose rate of rugged area is about 1.5 by using the image forming apparatus shown in FIG. 1 to compare image quality and fixability of output images of the three types of toners. States of the toner films coated on a rugged section of the recording medium were plotted on a basis of observation results by microscopically observing the output images. The toner elongation percentage was found by the tensile test as described above (FIG. 11).

Toner A: content of thermoplastic elastomer; 0 pts·mass (toner elongation percentage: 0%)

Toner B: content of thermoplastic elastomer; 35 pts·mass (toner elongation percentage: 20%)

Toner C: content of thermoplastic elastomer; 45 pts·mass (toner elongation percentage: 100%)

In a case when the toner A was used, the toner film was broken in transferring and fixing the toner film, the recording medium was seen through between the cracked toner film, and an image defect occurred as shown in FIG. 12B.

In a case when the toner B was used, a level of the image defect caused by the crack of the toner film was improved more than that of the toner A as shown in FIG. 12C. However, the toner film still cracked at parts where the ruggedness is large and caused an image defect.

In a case when the toner C was used, the toner film did not crack in transferring and fixing the toner film because the toner elongation percentage of the toner film is greater than the rate of rugged area of the recording medium P, and a fixed image of favorable image quality was obtained as shown in FIG. 12D.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-008983, filed on Jan. 22, 2013, which is hereby incorporated by reference herein in its entirety.

What is claimed is:

1. An image forming apparatus, comprising:
an intermediate transfer body;
a toner image forming portion configured to form a toner image corresponding to image data and to transfer the toner image to the intermediate transfer body;
a pressing and heating portion configured to form a toner film by heating the toner image carried on the intermediate transfer body to a toner softening temperature or more in a pressurized condition;
a pressing and cooling portion configured to cool down the toner film formed by the pressing and heating portion to a toner glass transition temperature or less in a pressurized condition;
an adhesive layer forming portion configured to form an adhesive layer, adhering the toner film to a recording medium, on at least one of the toner film cooled down by the pressing and cooling portion and the recording medium; and
a pressing portion configured to adhere the toner film to the recording medium by pressing the toner film, the adhesive layer and the recording medium in a body at a temperature of a toner glass transition temperature or less after forming the adhesive layer by the adhesive layer forming portion.

2. The image forming apparatus according to claim 1, wherein the adhesive layer forming portion forms the adhesive layer by applying an adhesive agent containing a water-soluble polymer and water to at least one of the toner film and the recording medium.

3. The image forming apparatus according to claim 2, wherein the water-soluble polymer of the adhesive agent contains a macromolecular monomer physically identical to the binder resin of the toner.

4. The image forming apparatus according to claim. 1, wherein the pressing and heating portion and the pressing and cooling portion are constructed as one unit, the one unit including:
a belt member forming a nip portion with the intermediate transfer body on a downstream of the toner image forming portion in a moving direction of the toner image;
a heating portion configured to heat an inner surface of the belt member; and
a cooling portion configured to cool down the belt member on a downstream of the heating member in the moving direction.

5. The image forming apparatus according to claim 3, wherein the pressing and heating portion and the pressing and cooling portion are constructed as one unit, and the one unit including:
a belt member forming a nip portion with the intermediate transfer body on a downstream of the toner image forming portion in a moving direction of the toner image;
a heating portion configured to heat an inner surface of the belt member; and
a cooling portion configured to cool down the belt member on a downstream of the heating member in the moving direction.

6. The image forming apparatus according to claim 2, wherein the adhesive layer forming portion includes a liquid injection nozzle array and applies the adhesive agent to an area corresponding to a profile of the toner film by actuating the liquid injection nozzle array corresponding to the image data.

7. The image forming apparatus according to claim 1, wherein the intermediate transfer body includes an elastic layer configured to follow superficial ruggedness of the recording medium, and
wherein the toner image forming portion is configured to form the toner image by using toner containing a thermoplastic elastomer and a binder resin in a solid-soluble state.

8. The image forming apparatus according to claim 7, wherein the thermoplastic elastomer is contained with a rate of 20 pts·mass or more and less than 100 pts·mass with respect to 100 pts·mass of the binder resin.

9. The image forming apparatus according to claim 7, wherein an area elongation percentage of the toner film at a temperature of the toner film at the pressing portion in adhering the toner film to a recording medium by integrally pressing the toner film, the adhesive layer and the recording medium is greater than a rate of rugged area, where the rate of rugged area is a rate of sum total of a rugged area of a surface of the recording medium in a projected area to the projected area in a normal direction of the surface of the recording medium.

10. The image forming apparatus according to claim 1, wherein the toner image forming portion controls the toner loading amount in a case where a toner contact angle is 0<θ≦π/2 to meet the following Equation:
$$\frac{ρ V}{{10}^{- 10} π} < M < \frac{2 ρ D}{3 {sin}^{2} θ} {( \frac{8 + cos 3 θ - 9 cos θ}{16} )}^{2 / 3}$$
where, D [μm] denotes an average particle size of the toner, ρ [kg/m] denotes true density of the toner, θ [rad] denotes the toner contact angle on the intermediate transfer body at a fusion point of the toner, and M [kg/m²] denotes a maximum value of the toner loading amount.

11. The image forming apparatus according to claim 1, wherein the toner image forming portion controls the toner loading amount in a case where a toner contact angle is π≧θπ/2 to meet the following Equation:
$$\frac{ρ V}{{10}^{- 10} π} < M < \frac{2 ρ D}{3} {( \frac{8 + cos 3 θ - 9 cos θ}{16} )}^{2 / 3}$$
where, D [μm] denotes an average particle size of the toner, ρ [kg/m] denotes true density of the toner, θ [rad] denotes the toner contact angle on the intermediate transfer body at a fusion point of the toner, and M [kg/m²] denotes a maximum value of the toner loading amount.

12. An image forming apparatus comprising:
an intermediate transfer belt;
a toner image forming portion configured to form a toner image on the intermediate transfer belt;
a toner film forming portion configured to form a nip portion with the intermediate transfer belt on a downstream of the toner image forming portion in a moving direction of the toner image and to form a toner film by heating the toner image at the nip portion, the toner film forming portion including a heating portion configured to heat the toner image and a cooling portion configured to cool down the toner film formed by the heating portion; and
an adhesion portion configured to adhere the toner film with a recording medium.

13. The image forming apparatus according to claim 12, wherein the toner film forming portion further includes:
a rotator disposed downstream in the moving direction of the heating portion; and
an endless belt member wrapped around the heating portion and the rotator;
wherein the cooling portion is disposed between the heating portion and the rotator and is configured to cool down an inner circumferential surface of the belt member between the heating portion and the rotator.

14. The image forming apparatus according to claim 13, wherein the toner film forming portion further includes a pressing member disposed inside of the endless intermediate transfer belt and pressing the intermediate transfer belt from an inner circumferential surface thereof toward the belt member.

15. The image forming apparatus according to claim 12, wherein the heating portion heats the toner image to a toner softening temperature or more; and
the cooling portion cools down the toner film to a glass transition temperature or less.

16. The image forming apparatus according to claim 14, wherein the heating portion heats the toner image to a toner softening temperature or more; and
the cooling portion cools down the toner film to a glass transition temperature or less.

17. The image forming apparatus according to claim 16, wherein the adhesion portion includes:
a pressing portion configured to press the recording medium and the toner film formed by the toner film forming portion in a body; and
an adhesive supplying portion configured to supply an adhesive agent to a surface of the toner film to be adhered to the recording medium between the toner film forming portion and the pressing portion.

18. The image forming apparatus according to claim 16, wherein the adhesion portion includes:
a pressing portion configured to press the recording medium and the toner film formed by the toner film forming portion in a body; and
an adhesive supplying portion provided upstream in the recording medium moving direction of the pressing portion and configured to supply an adhesive agent to a surface of the recording medium to be adhered with the toner film.

19. The image forming apparatus according to claim 16, wherein the adhesion portion includes a pressing portion configured to adhere the toner film to the recording medium by pressing the recording medium on which an adhesive layer adhering the toner film is formed in advance and the toner film formed by the toner film forming portion in a body.

20. The image forming apparatus according to claim 15, wherein the toner image forming portion controls the toner loading amount in a case where a toner contact angle is 0<θ≦π/2 to meet the following Equation:
$$\frac{ρ V}{{10}^{- 10} π} < M < \frac{2 ρ D}{3 {sin}^{2} θ} {( \frac{8 + cos 3 θ - 9 cos θ}{16} )}^{2 / 3}$$
where, D [μm] denotes an average particle size of the toner, ρ [kg/m³] denotes true density of the toner, θ [rad] denotes the toner contact angle on the intermediate transfer body at a fusion point of the toner, and M [kg/m²] denotes a maximum value of the toner loading amount.

21. The image forming apparatus according to claim 15, wherein the toner image forming portion controls the toner loading amount in a case where a toner contact angle is π≧θ>π/2 to meet the following Equation:
$$\frac{ρ V}{{10}^{- 10} π} < M < \frac{2 ρ D}{3} {( \frac{8 + cos 3 θ - 9 cos θ}{16} )}^{2 / 3}$$
where, D [μm] denotes an average particle size of the toner, ρ [kg/m] denotes true density of the toner, θ [rad] denotes the toner contact angle on the intermediate transfer body at a fusion point of the toner, and M [kg/m²] denotes a maximum value of the toner loading amount.
